(19) United States
(12) Patent Application Publication
(10) Pub. No.: US 2007/0138789 A1
(43) Pub. Date: Jun. 21, 2007

(54) Leadthrough for a constructional component

(75) Inventors: Herbert Muenzenberger, Wiesbaden (DE); Manfred Klein, Kaufering (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellscahft

(21) Appl. No.: 11/638,158

(22) Filed: Dec. 12, 2006

(30) Foreign Application Priority Data
Dec. 21, 2005 (DE) 10 2005 000 197.1

(51) Int. Cl. F16L 5/00; E04C 2/52; F16L 41/00

(52) U.S. Cl. 285/189; 285/39; 285/192; 52/220.1

(57) ABSTRACT

A leadthrough (10) for constructional components (30) includes a clad tube (11) extendable through the constructional component (30) and provided with a cutting profile (14) at its end surface (12) for forming a bore for the clad tube (11); with a coupling element (15) for connecting the clad tube (11) with a rotary drive, and with an edge protecting element (16) for covering the cutting profile (14).

### BACKGROUND OF THE INVENTION

1. Field of the Invention

The present invention relates to a leadthrough for a constructional component and having a clad tube extendable through the constructional component.

2. Description of the Prior Art

Leadthroughs of the type described above are used for passing of conduits such as, e.g., tubular conduits or cable channels, through constructional components such as, e.g., walls or ceilings. With such leadthroughs, an opening, which is formed in a constructional component, is lined up with a protective or clad tube. Through this protective or clad tube, a conduit is inserted and is sealed relative to the protective tube.

German Publication DE 103 13 305 A1 discloses a clad tube for forming leadthroughs which is formed of a substantially cylindrical basic tube surrounded with a plurality of circumferentially arranged lamellas and having at its opposite end regions, sections, respectively, having a larger diameter.

A drawback of such protective or clad tubes consists in that an opening needs to be formed in a constructional component with a saw before insertion of the clad tube.

Accordingly, an object of the present invention is to provide a leadthrough that can be rapidly formed in a constructional component.

### SUMMARY OF THE INVENTION

This and other objects of the present invention, which will become apparent hereinafter, are achieved by providing a leadthrough including a clad tube that is provided with a cutting profile at an end surface and with coupling means for connecting the clad tube with a rotary drive, and with edge protecting means for covering the cutting profile.

The leadthrough according to the present invention is mounted in a single operational step, with the opening being formed by the clad tube itself. The cutting profile is covered, after the completion of the cutting process, with the edge protecting means to prevent any damage of a conduit extendable through the clad tube.

Advantageously, the coupling means is provided at the clad tube end remote from the end surface with the cutting profile and which, advantageously, is also covered by edge protecting means. This also prevents any damage of the conduit extendable through the leadthrough. The coupling means can be formed, e.g., as pocket-shaped recesses into which pins associated with the rotary drive, can engage.

Preferably, the edge protecting means and the further edge protecting means are formed each as a plastic ring having an annular groove for receiving, respectively, the respective end surface and the tubular end. Such plastic rings can be produced with little costs and can be mounted on the end surface and/or the tube end with the coupling means during transportation and storage of the clad tubes. Thereby, the tube ends are protected, on one hand and, on the other hand, the edge protecting elements or means are readily available after mounting of the clad tube.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiment, when read with reference to the accompanying drawings.

### BRIEF DESCRIPTION OF THE DRAWINGS:

The drawings show:

FIG. 1 a perspective view showing a process of mounting of a leadthrough according to the present invention and including a clad tube, in a wall;

FIG. 2 a perspective view showing the leadthrough of FIG. 1 in a mounted condition;

FIG. 3 a side view of a clad tube of a leadthrough according to the present invention arranged on a rotary drive adapter; and

FIG. 4 a view showing edge protecting means of leadthrough shown in FIG. 2.

### DETAILED DESCRIPTION OF THE PREFERRED EMBODIMENT

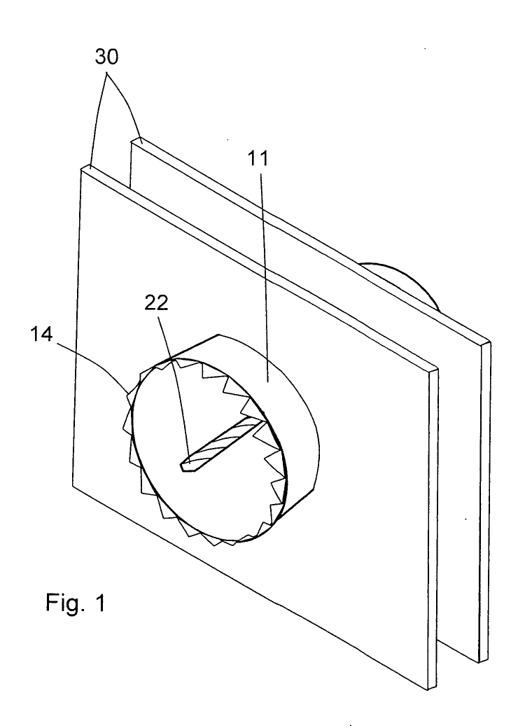

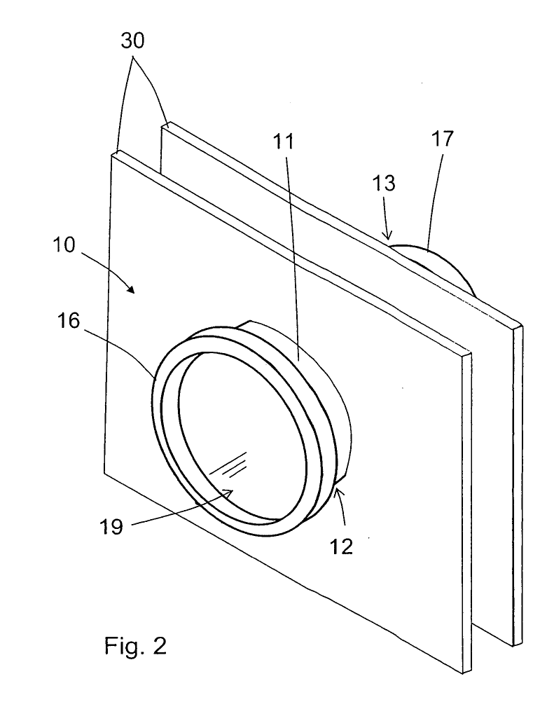

A leadthrough 10 according to the present invention, which is shown in FIGS. 1-2, is arranged in a two-sheet light constructional wall that forms a constructional component 30 and includes a protective or clad tube 11 on the end surface 12 of which, there is provided a cutting profile 14 with a plurality of separate saw teeth (FIG. 1). The saw teeth are formed integrally with the clad tube 11. Alternatively, the cutting profile 14 can be formed instead of saw teeth, by another cutting bodies.

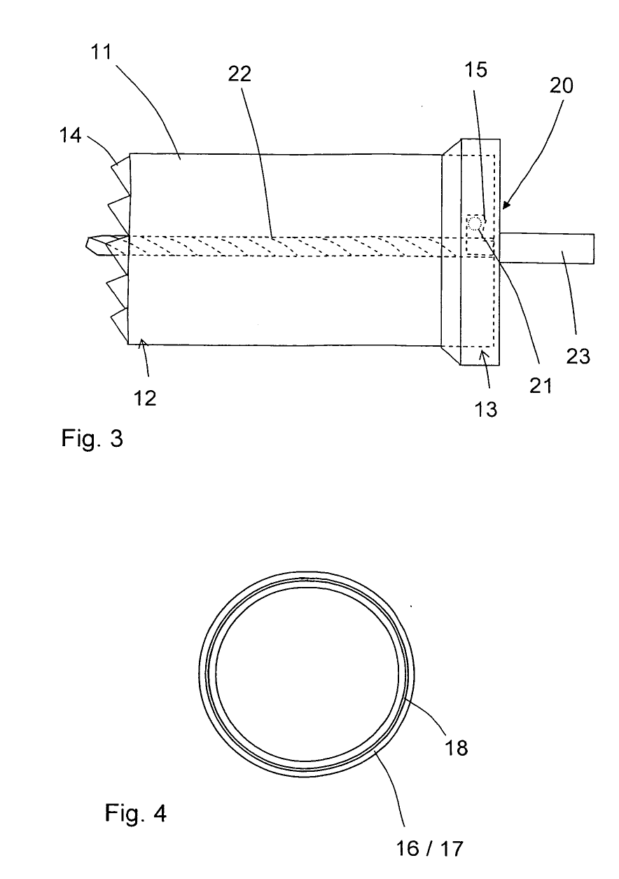

As shown in FIG. 3, the clad tube 11 has, in addition to the cutting profile 14, at its tubular end 13 opposite the end surface 12, coupling means 15. The coupling means 15 is formed as pocket-shaped recesses of which there are provided, e.g., from two to four recesses. The coupling means 15 is adapted to connect the clad tube 11 with a rotary drive. In the embodiment shown in FIG. 3, the coupling means 15 connects the clad tube 11 with a rotary drive adaptor 20 that is provided to this end with a corresponding number of matching coupling elements 21 which are formed, e.g., as pins. The rotary drive adaptor 20 further has an axially extending shank 23 with which the rotary drive adapter 20 is connectable with a rotary drive (not shown), e.g., a drill. An axially arranged drill 22, which is provided on the rotary drive adaptor 20, serves for centering of the clad tube 11 during a drilling process.

FIG. 1 shows how the clad tube 11 is inserted in the constructional component 30, using the rotary drive adaptor 20. After the clad tube 11 has been drilled into the constructional component 30, the rotary drive adaptor 20, together with the drill 22 is removed, with matching coupling means 21 of the drive adaptor 20 being disconnected from coupling means 15 of the clad tube 11. After removal of the rotary drill adaptor 20, the end surface 12 and the tubular end 13 are covered with respective edge protecting elements 16, 17, completing installation of the leadthrough 10 in the constructional component 30 (please see FIG. 2). The edge protecting elements 16, 17 are formed as plastic rings, one of which is shown in the view shown in FIG. 4. The plastic rings 16, 17 each has a circumferential annular groove 18 for accommodating the end surface 12 with the cutting profile 14 or the tubular end 13 with the coupling means 15.

The leadthrough 10, which is shown in FIG. 2, has a cylindrical inner space 19 extending through the constructional component 30 and through which a conduit (not shown) can be extended.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A leadthrough (10) for being mounted in a constructional component (30), comprising a clad tube (11) extendable through the constructional component (30) and provided with a cutting profile (14) at an end surface (12) thereof for forming an opening in the constructional component for the leadthrough (10), and with coupling means (15) for connecting the clad tube (11) with a rotary drive; and edge protecting means (16) for covering the cutting profile (14).

2. A leadthrough according to claim 1, wherein the coupling means (15) is provided at a tube end (13) remote form the end surface (12).

3. A leadthrough according to claim 2, comprising further edge protecting means (17) for covering the coupling means (15).

4. A leadthrough according to claim 1, wherein the edge protecting means (16) is formed as a plastic ring having an annular groove (18) for receiving the end surface (12).

5. A leadthrough according to claim 3, wherein the edge protecting means (16) and the further edge protecting means (17) are formed each as a plastic ring having an annular groove (18) for receiving, respectively, the end surface (12) and the tubular end (13).
